(19) United States
(12) Patent Application Publication
(10) Pub. No.: US 2026/0282012 A1
(43) Pub. Date: Sep. 17, 2026

(54) SSB RECYCLE VIA UE-SIDE BEAM PREDICTION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/470,767

(22) PCT Filed: Jun. 9, 2023
(86) PCT No.: PCT/CN2023/099364

§ 371 Date: Sep. 29, 2025

(51) Int. Cl. H04W 72/1273

(52) U.S. Cl. CPC H04W 72/1273

(57) ABSTRACT

A method for wireless communication at a user equipment (UE) and related apparatus are provided. In the method, a UE receives, from a network entity via a first medium access control (MAC)-control element (MAC-CE) or first downlink control information (DCI), a first synchronization signal block (SSB) indication. Based on the first SSB indication, the UE refrains from transmitting one or more SSBs. The one or more SSBs are based on a radio resource control (RRC) configuration. The UE then determines, based on the first SSB indication, a first rate-matching pattern for a first DL signal for the UE. The first DL signal is allowed to be scheduled overlapping with a set of transmission resources originally occupied by the one or more SSBs. The method improves the efficiency of wireless communication by reducing SSB overhead, enhancing scheduling flexibility, and improving the utilization of transmission resources.

### TECHNICAL FIELD

The present disclosure relates generally to communication systems, and more particularly, to synchronization signal block (SSB) recycling via beam prediction on the user equipment (UE) side in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity via a first medium access control (MAC)-control element (MAC-CE) or first downlink control information (DCI), a first synchronization signal block (SSB) indication; refrain, based on the first SSB indication, from transmitting one or more SSBs, where the one or more SSBs are based on a radio resource control (RRC) configuration; and determine, based on the first SSB indication, a first rate-matching pattern for a first DL signal for the UE. The first DL signal may be allowed to be scheduled overlapping with a set of transmission resources originally occupied by the one or more SSBs.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to configure a first SSB indication, where the first SSB indication indicates for a UE to refrain from transmitting one or more SSBs; and transmit, for the UE via a MAC-CE or first DCI, the first SSB indication. The first SSB indication causes the UE to refrain from transmitting the one or more SSBs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of SSBs restricting scheduling flexibility.

FIG. 4B is a diagram illustrating an example of a relaxed scheduling constraint with respect to SSBs.

FIG. 5 is a diagram illustrating an example of refrained or resumed transmission of SSBs via MAC-CE or DCI in accordance with various aspects of the present disclosure.

FIG. 6A is a diagram illustrating an example of dynamic UE rate-matching patterns based on refrained SSBs in accordance with various aspects of the present disclosure.

FIG. 6B is a diagram illustrating an example of dynamic UE rate-matching patterns based on resumed SSBs in accordance with various aspects of the present disclosure.

FIG. 7 is a diagram illustrating an example of refraining or resuming the transmission of certain SSBs in accordance with various aspects of the present disclosure.

FIG. 8 is a diagram illustrating an example of the selection among multiple candidate choices of SSBs in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a network entity in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

In wireless communication, SSBs play a role in assisting a UE in various tasks or functionalities, such as channel quality measurement, cell identification, beam management, and time and frequency synchronization. However, the SSBs occupy a large amount of overhead, which in turn, limits scheduling flexibility. For example, due to analog beamforming, the whole symbols occupied by a certain SSB may need to be transmitted via the same beam as that transmitting the SSB, which makes scheduling of UEs not desiring such beam less flexible. Additionally, for UEs with beam prediction capabilities, even though UE-side beam prediction using SSB was possible, the condition for the actual transmission of the SSBs remained, resulting in less than optimal communication efficiency. Given these limitations, example aspects present herein provide various signaling enhancement mechanisms that contribute to improved scheduling flexibility, reduced overhead, and optimized utilization of communication resources.

Various aspects relate generally to communication systems. Some aspects more specifically relate to SSB recycling via beam prediction on the UE side in wireless communication. In some examples, a UE may receive, from a network entity via a first MAC-CE or first DCI, a first SSB indication. Based on the first SSB indication, the UE may refrain from transmitting one or more SSBs. The one or more SSBs may be based on an RRC configuration. The UE may determine, based on the first SSB indication, a first rate-matching pattern for a first DL signal for the UE. The first DL signal may be allowed to be scheduled overlapping with a set of transmission resources originally occupied by the one or more SSBs.

Particular aspects of the subject matter described in this disclosure can be implemented to realize one or more of the following potential advantages. By enabling efficient and dynamic SSB recycling through the use of MAC-CE or DCI signaling, the described techniques can be used to reduce SSB overhead, enhance scheduling flexibility, and improve the utilization of transmission resources. In some examples, by implementing a method for SSBs targeted for prediction not necessary for actual transmission, the described techniques can be used to improve resource utilization. In some examples, by allowing for the overlapping or non-overlapping scheduling of downlink (DL) signals with SSBs depending on the MAC-CE/DCI signals received, the described techniques can be used to improve scheduling flexibility.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

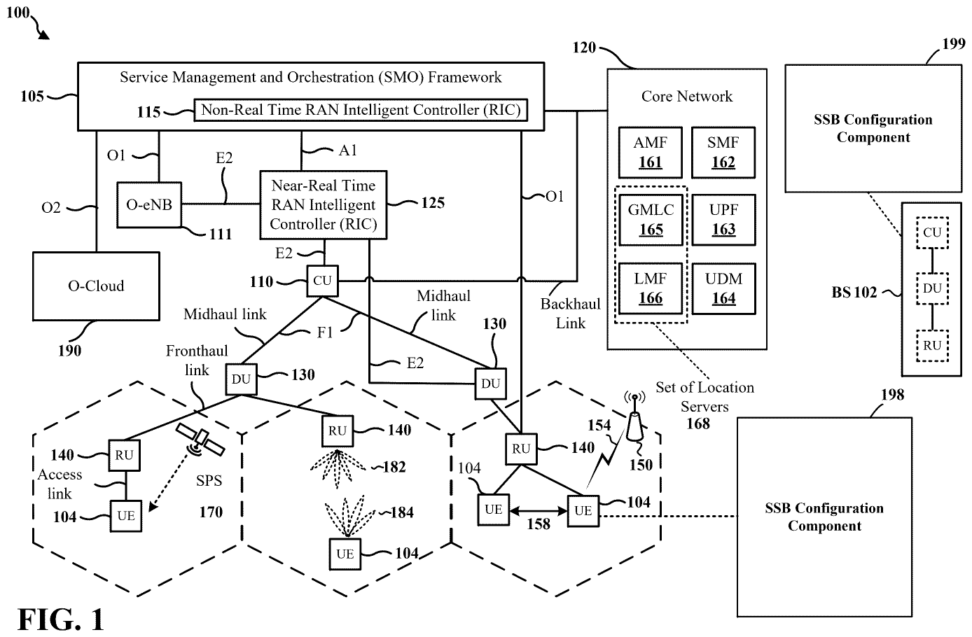

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SSB configuration component 198. The SSB configuration component 198 may be configured to receive, from a network entity via a first MAC-CE or first DCI, a first SSB indication; refrain, based on the first SSB indication, from transmitting one or more SSBs, where the one or more SSBs are based on an RRC configuration. The SSB configuration component 198 may be further configured to determine, based on the first SSB indication, a first rate-matching pattern for a first DL signal for the UE. The first DL signal may be allowed to be scheduled overlapping with a set of transmission resources originally occupied by the one or more SSBs. In certain aspects, the base station 102 may include an SSB configuration component 199. The SSB configuration component 199 may be configured to configure a first SSB indication. The first SSB indication may indicate for a UE to refrain from transmitting one or more SSBs. The SSB configuration component 199 may be further configured to transmit, for the UE via a first MAC-CE or first DCI, the first SSB indication. The first SSB indication may cause the UE to refrain from transmitting the one or more SSBs. Although the following description may be focused on 5G NR, the concepts described herein may be applicable to other similar areas, such as LTE, LTE-A, CDMA, GSM, and other wireless technologies.

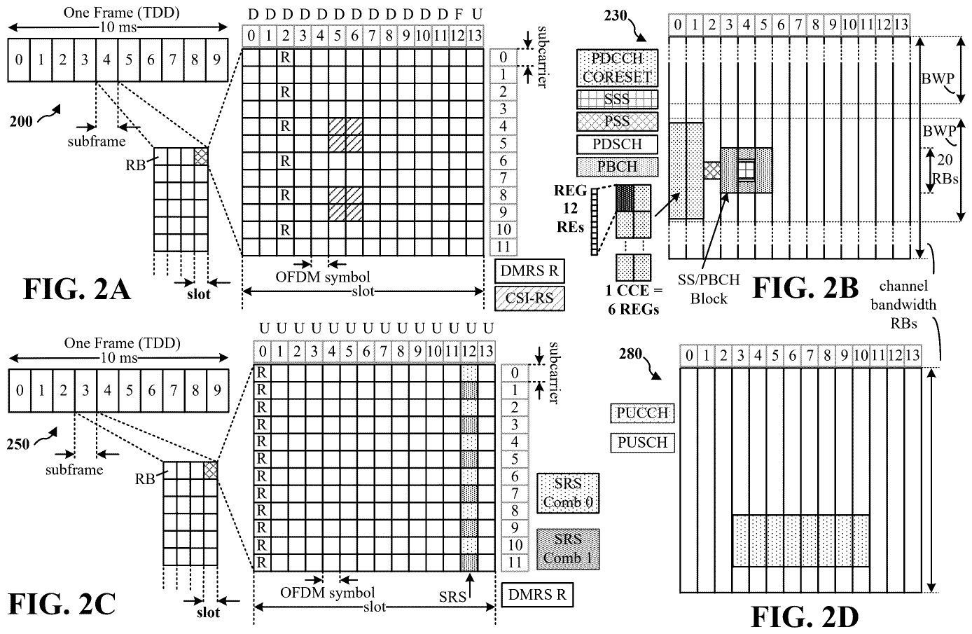

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

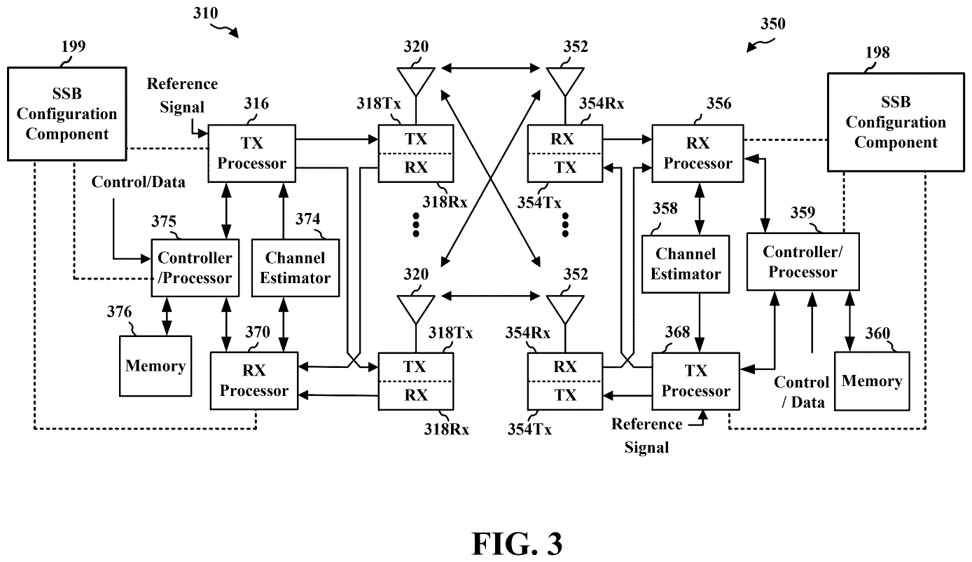

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SSB configuration component 198 of FIG. 1.

At least one of the TX processor 316, the RX processor 370, and the controller/processor 375 may be configured to perform aspects in connection with the SSB configuration component 199 of FIG. 1.

Example aspects describe mechanisms for skipping the transmission of SSBs (so that measurements can be predicted). In some aspects, a UE receives MAC-CE/DCI based indication from the base station regarding whether a certain actually transmitted SSB identified based on an RRC configuration (e.g., ssb-PositionInBurst from a remaining system information (RMSI) configuration) is refrained from the transmission. In some aspects, the UE applies dynamic rate-matching patterns based on the received MAC-CE/DCI based indication.

The SSB may be used to facilitate the beam management process between a UE and the base station. For example, the base station may transmit one or more SSBs on different beams to the UE, and the UE may use the received signal quality of the SSBs to determine the beam(s) that provide satisfactory signal strength.

In the sub-6 GHz frequency range, the number of SSBs may be up to 8, and a full bitmap of 8 bits may be used to indicate actual SSB transmissions. Each bit within the bitmap may correspond to a specific SSB. In the frequency range above 6 GHZ, the number of SSBs can reach up to 64, and a compressed method may be used to indicate actual SSB transmissions. This method may include two components: a group-bitmap of 8 bits and a bitmap in group, also of 8 bits. In this method, a “group” is defined as a set of consecutive SSBs. The bitmap in group may indicate which SSB within the group is actually transmitted, and each group may have the same pattern of SSB block transmission. The group-bitmap may indicate which group is actually transmitted.

Example aspects presented herein address the challenges associated with SSB-based beam management (BM) in, for example, FR2. Particularly, the example aspects address the issue of SSBs occupying a large amount of overhead and limiting scheduling flexibility.

Due to analog beamforming, the whole symbols occupied by a particular SSB may be transmitted via the same beam that transmits the SSB, which makes scheduling of UEs not desiring such a beam less flexible. Additionally, even for UEs that can be scheduled on the symbols occupied by a specific SSB, rate-matching around the SSB may still be needed, as PDSCH may not overlap with SSBs.

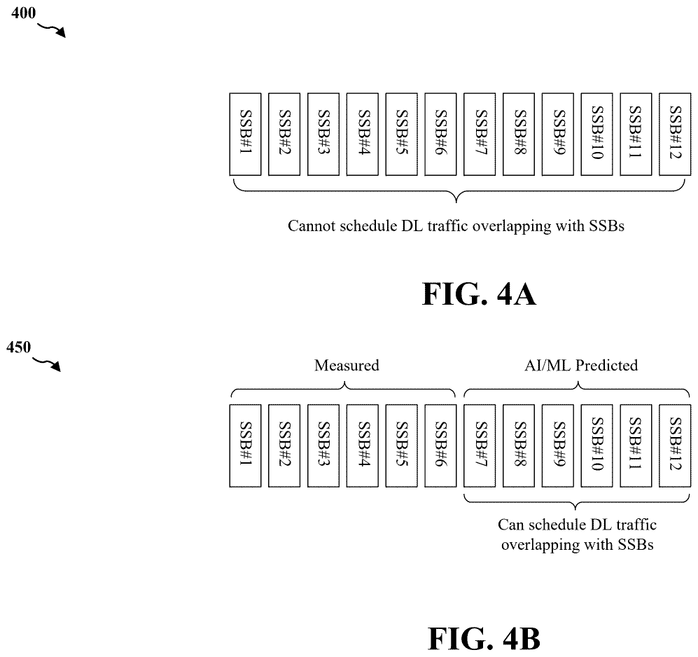

When UE-side beam prediction using SSB is possible (for instance, predicting the first set of SSBs' layer 1 (L1) Reference Signal Received Power (L1-RSRP) via a second set of SSBs), the SSBs that are the target of the prediction may not need to be actually transmitted. Hence, if the network identifies a larger number of UEs with such beam prediction capabilities, those SSBs as prediction targets may be recycled (e.g., the transmission resources associated with those SSBs may be utilized by other transmissions), thus resolving the aforementioned problems. This recycling does not compromise the performance of other legacy UEs (e.g., UEs that are not the target of the beam prediction or lack the beam prediction capabilities). For the legacy UEs, if the network identifies that such UEs may not need to rely on the recycled SSBs, such SSB recycling mechanisms do not adversely affect their performance. FIG. 4A is a diagram 400 illustrating an example of SSBs restricting scheduling flexibility. In FIG. 4A, the whole symbols occupied by a certain SSB (e.g., SSB #1 in FIG. 4A) may be transmitted via the same beam. Hence, the UE may not schedule DL traffic overlapping with SSBs. FIG. 4B is a diagram 450 illustrating an example of a relaxed scheduling constraint with respect to SSBs. In FIG. 4B, if one set of SSBs' L1-RSRP (e.g., SSB #7-SSB #12) may be predicted based on another set of SSBs (e.g., SSB #1-SSB #6), the SSBs as prediction target (i.e., SSB #7-SSB #12) may not need to be actually transmitted. Hence, the UE may schedule DL traffic overlapping with these SSBs.

Example aspects presented herein provide signaling enhancement details to implement the above solutions, thereby reducing SSB overhead, enhancing scheduling flexibility, and improving the utilization of transmission resources.

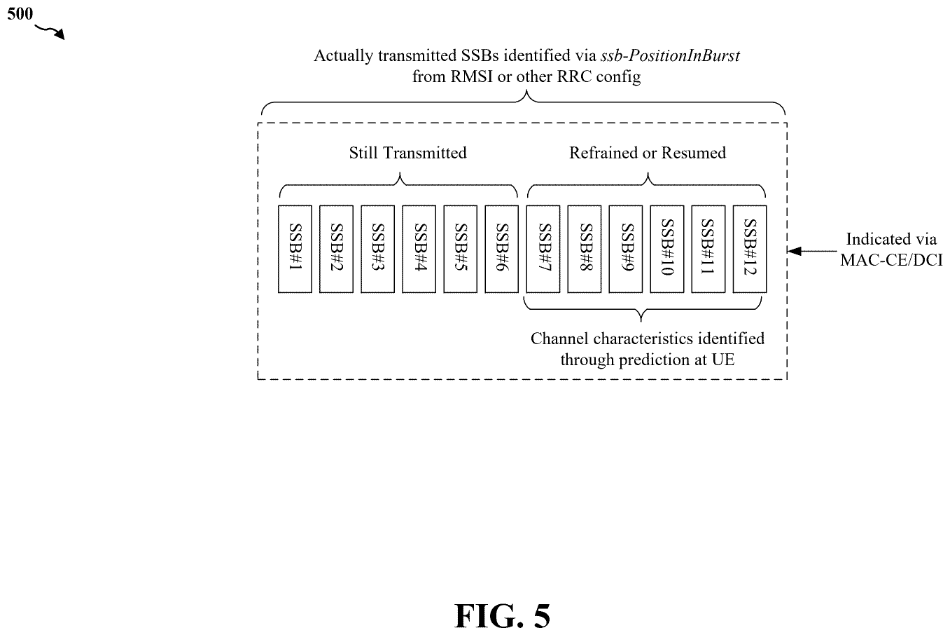

In some aspects, an SSB recycling indication mechanism for UEs with beam prediction capabilities may be provided. This mechanism allows the UE to receive an indication from a base station (e.g., a gNB). The indication, which may be referred to as “the SSB recycling indication,” may be delivered via MAC-CE or DCI, and may specify whether a certain actually transmitted SSB, identified based on an RRC configuration may be refrained from transmitting. As used herein, “RRC configuration” may refer to the configuration implemented via the RRC layer. The RRC configuration may be, for example, ssb-PositionInBurst from the remaining system information (RMSI) configuration or other RRC configurations, which may include ServingCellConfigCommon or SSB-MTC-AdditionalPCI-r17 configurations, among others. Additionally, the MAC-CE/DCI based indication may further include information about whether an SSB, initially refrained from transmitting, is resumed again for transmission. FIG. 5 is a diagram 500 illustrating an example of refrained or resumed transmission of SSBs via MAC-CE or DCI in accordance with various aspects of the present disclosure. In FIG. 5, an RRC configuration (e.g., ssb-PositionInBurst from the RMSI configuration (i.e., the configuration implemented via RMSI)) may identify a set of actually transmitted SSBs (e.g., SSB #1-SSB #12). Among the set of actually transmitted SSBs (e.g., SSB #1-SSB #12), some SSBs (e.g., SSB #7-SSB #12) may be refrained from transmitting via a MAC-CE or DCI based indication. Additionally, the MAC-CE or DCI based signaling may further instruct the resumption of transmitting the SSBs that were previously refrained from transmitting (e.g., SSB #7-SSB #12).

In some aspects, the SSB recycling indication may be related to UE capabilities. For example, UEs that have reported relevant capabilities may expect to receive the aforementioned MAC-CE/DCI based signaling. These capabilities may include at least one of: a general support for receiving such MAC-CE/DCI based signaling, a support for receiving MAC-CE-based signaling but not DCI-based signaling, a support for receiving DCI-based signaling but not MAC-CE-based signaling, or the ability to predict L1-RSRPs of SSBs, thereby implicitly supporting the receipt of the aforementioned MAC-CE/DCI based signaling.

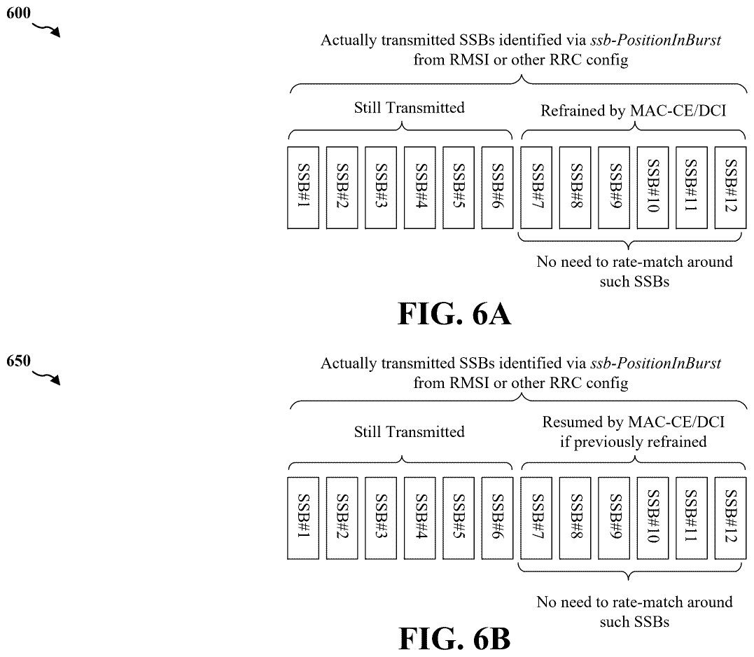

Example aspects presented herein further provide dynamic rate-matching patterns for the UE based on the MAC-CE or DCI based signaling. In some aspects, a UE receiving the MAC-CE or DCI based signaling may apply dedicated rate-matching patterns based on the MAC-CE or DCI based signaling. For example, if the MAC-CE/DCI based signaling indicates the refrain from transmitting a specific SSB, the UE may determine its rate-matching patterns for other DL signals such that the DL signals can be scheduled to overlap with the time domain and frequency domain resources originally occupied by the refrained SSBs. These DL signals may include, for example, PDSCH, PDCCH, and CSI-RS, among others. FIG. 6A a diagram 600 illustrating an example of dynamic UE rate-matching patterns based on refrained SSBs in accordance with various aspects of the present disclosure. In FIG. 6A, an RRC configuration (e.g., ssb-PositionInBurst from the RMSI configuration) may identify a set of actually transmitted SSBs (e.g., SSB #1-SSB #12). Among the set of actually transmitted SSBs (e.g., SSB #1-SSB #12), some SSBs (e.g., SSB #7-SSB #12) may be refrained from transmitting via a MAC-CE or DCI based indication. Hence, when the UE determines its rate-matching patterns for DL signals, the DL signals may be scheduled to overlap with transmission resource (e.g., the time domain and frequency domain resources) originally occupied by the refrained SSBs (e.g., SSB #7-SSB #12). As used herein, the “rate-matching pattern” may refer to a procedure of adjusting the data rate or the size of the transport block for the communication (e.g., the communication between the UE and the base station).

Conversely, if the MAC-CE/DCI based signaling indicates the resumption of transmitting for one or more specific SSBs that were previously refrained from transmitting, the UE may determine its rate-matching patterns for other DL signals such that the DL signals may not be scheduled to overlap with the time domain and frequency domain resources occupied by the resumed SSB. These DL signals may include, for example, PDSCH, PDCCH, and CSI-RS, among others. FIG. 6B is a diagram 650 illustrating an example of dynamic UE rate-matching patterns based on resumed SSBs in accordance with various aspects of the present disclosure. In FIG. 6B, an RRC configuration (e.g., ssb-PositionInBurst from the RMSI configuration) may identify a set of actually transmitted SSBs (e.g., SSB #1-SSB #12). Among the set of actually transmitted SSBs (e.g., SSB #1-SSB #12), some SSBs (e.g., SSB #7-SSB #12) may be previously refrained from transmitting via a MAC-CE or DCI based indication. Subsequently, a MAC-CE/DCI based signaling may indicate the resumption of transmitting for these SSBs (e.g., SSB #7-SSB #12). Then, when the UE determines its rate-matching patterns for DL signals, the DL signals may not be scheduled to overlap with transmission resource (e.g., the time domain and frequency domain resources) occupied by the resumed SSBs (e.g., SSB #7-SSB #12).

In some aspects, for MAC-CE-based signaling pertaining to the refraining or resuming the transmission of certain SSBs can be based on at least one of the following mechanisms.

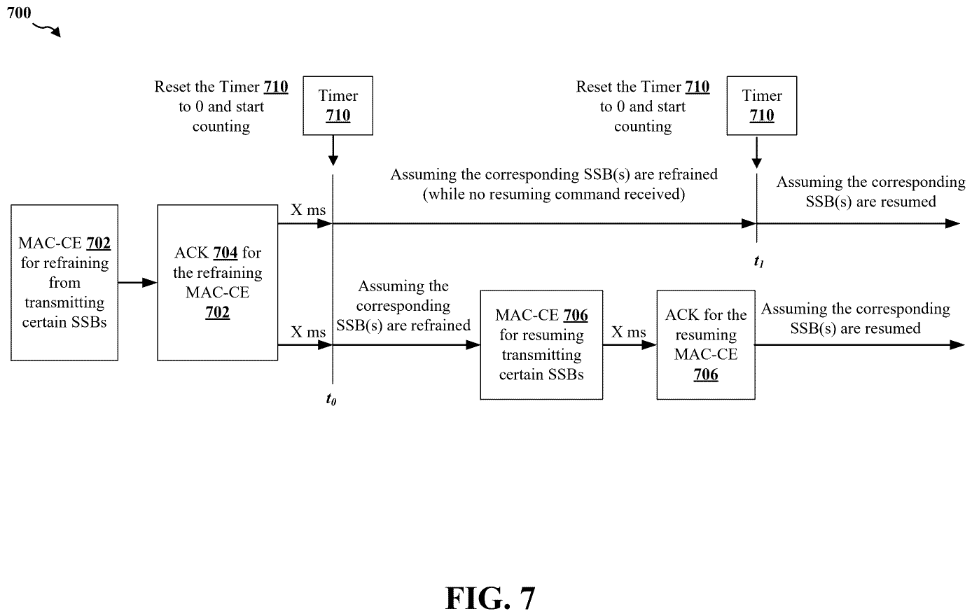

In one example, the UE may apply its downlink rate-matching patterns based on the indicated refraining or resuming the transmission of certain SSBs a certain time (e.g., X milliseconds) after the UE has transmitted an acknowledgment (ACK) associated with the MAC-CE. The value of the time (e.g., the value of X) may be predefined. FIG. 7 is a diagram 700 illustrating an example of refraining or resuming the transmission of certain SSBs in accordance with various aspects of the present disclosure. In FIG. 7, the UE may receive a MAC-CE indication (e.g., MAC-CE 702) for refraining from transmitting certain SSBs. The UE may send an ACK 704 for the refraining MAC-CE 702. Then, the UE may apply its downlink rate-matching patterns based on the indicated refraining of transmitting certain SSBs a certain time (e.g., X milliseconds) after the UE has transmitted the ACK 704 associated with the refraining MAC-CE 702.

In another example, the indication contained within the MAC-CE-based signaling may be applied to the BWP in which the UE received such MAC-CE-based signaling. For example, if the UE receives a MAC-CE-based signal indicating the refraining of the transmission of an SSB within a BWP of B₁, the refraining of the transmission may apply to SSB within the BWP of B₁.

In another example, the MAC-CE may further include Service Cell ID(s) and/or BWP-ID(s), allowing the indication contained in such MAC-CE to be applied to the indicated Service Cell(s) and/or BWP(s). For example, a MAC-CE may include an indication to refrain from transmitting a certain SSB and a service cell ID of Id₁, and the refrainment may apply to the SSB associated with the service cell ID Id₁.

In yet another example, the UE may be directly indicated by the MAC-CE with an alternate configuration differing from the one identified via RRC, such as an alternate ssb-PositionInBurst configuration. The alternate configuration (e.g., the alternate ssb-PositionInBurst configuration) indicated by the MAC-CE may be further enhanced for FR2 over the existing bits indication (e.g., by directly utilizing 64 bits for indicating the transmission of SSBs for better flexibility).

Example aspects present herein further provide a timer-based resuming mechanism for the MAC-CE-based signaling. In some aspects, after a certain time (e.g., X milliseconds) of the UE sending an acknowledgment for the reception of the MAC-CE-based signaling, the UE may set a dedicated timer to zero. The UE then may increase the timer for every slot until the timer reaches a timing threshold, which may be a predefined value. If the timer has reached the timing threshold and the UE does not receive further indications from the base station on resuming the transmission of SSBs previously refrained by the MAC-CE-based signaling, the UE may autonomously assume that such refrained transmission of SSBs have been resumed. Referring to FIG. 7, after a certain time (e.g., X milliseconds) of the UE sending the ACK 704 for the reception of the refraining MAC-CE 702, the UE may set a timer 710 to zero (at t₀). The value of the timer 710 may increase with each slot. In some aspects, for DCI-based signaling pertaining to the refraining of the transmission of a certain SSB, the DCI-based signaling may be Downlink-grant DCI, applicable regardless of whether the PDSCH is scheduled or not, since an acknowledgment/negative acknowledgment (ACK/NACK) associated with such DCI is expected. If the timer 710 has reached the timing threshold (e.g., at t₁) and the UE does not receive further indications from the base station on resuming the transmission of SSBs previously refrained by the MAC-CE-based signaling (e.g., MAC-CE 702), the UE may autonomously assume that such refrained transmission of SSBs have been resumed.

In some aspects, a UE may be preconfigured via RRC and/or indicated by MAC-CE with multiple distinct choices of, for example, ssb-PositionInBurst configurations within a specific service Cell. The DCI-based signaling then may selectively choose one choice from these multiple choices.

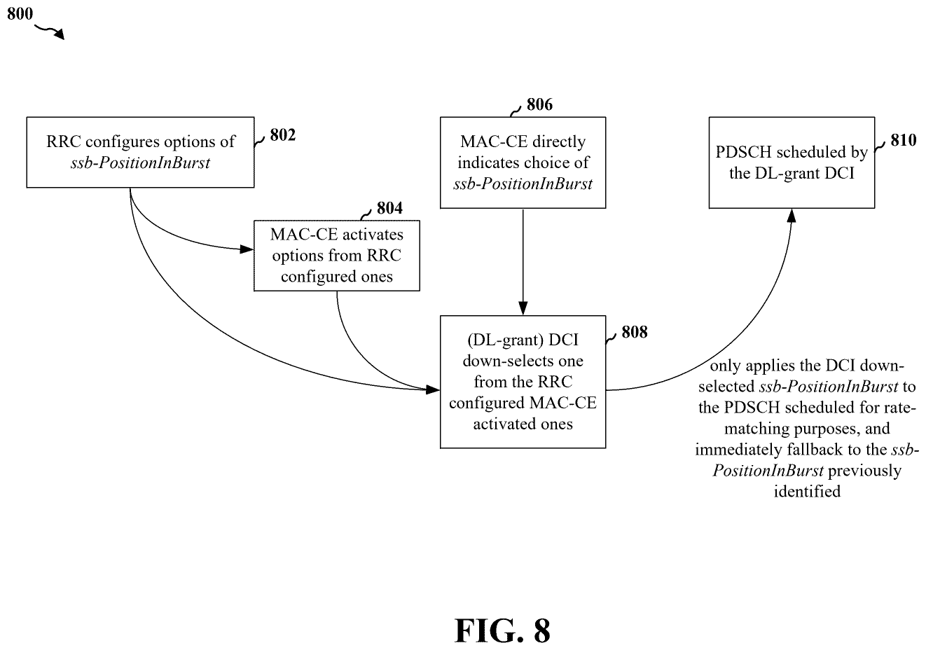

FIG. 8 is a diagram 800 illustrating an example of the selection among multiple candidate choices of SSBs in accordance with various aspects of the present disclosure. Referring to FIG. 8, in one example, the UE may, at 802, be RRC configured with multiple options of, for example, ssb-PositionInBurst configurations within a certain service cell, and the MAC-CE may further activate, at 804, a subset of the RRC configured options. The DCI then may selectively choose, at 808, one option from the multiple options activated by MAC-CE.

In another example, the UE may, at 802, be RRC configured with multiple options of, for example, ssb-PositionInBurst configurations within a certain Service Cell, and the DCI may, at 808, selectively choose one option from these RRC configured options.

In yet another example, the UE may be, at 806, directly indicated by MAC-CE with multiple options of, for example, ssb-PositionInBurst configurations within a certain service cell, and the DCI may, at 808, selectively choose one option from these configured options.

The ssb-PositionInBurst configuration configured by RRC or indicated by MAC-CE can be further enhanced for FR2, over the existing bits indication (e.g., by directly utilizing 64 bits to indicate the transmission of SSBs for better flexibility).

In some aspects, the SSB may be refrained for transmission for the PDSCH scheduled by the DCI at 810. In a scenario where the DCI is a downlink-grant DCI scheduling a PDSCH, the UE may assume that the associated SSB(s) are refrained from transmitting during the time domain resources where the PDSCH is scheduled. For other time domain resources where the PDSCH is not scheduled, the UE may not apply the indications received in the DCI.

In some aspects, after a certain time (e.g., X milliseconds, the value of X may be predefined) of the UE sending an acknowledgement for the reception of the DCI-based signaling indicating the refraining of transmitting SSBs, the UE may assume that the SSB refraining indicated by the DCI-based signaling are applied for any DL signals' rate-matching pattern (similarly as for MAC-CE-based indication).

In some examples, the UE may receive another DCI that invalidates the previously signaled SSB refraining. The UE may then apply such invalidation a certain time (e.g., X milliseconds) after it sends an ACK concerning this subsequent DCI.

Example aspects presented herein further provide a timer-based refraining and resuming mechanism for DCI-based signaling. In some aspects, after a certain time (e.g., X milliseconds) of the UE sending an ACK with regard to the DCI indicating the refraining of transmission of SSBs, the UE may set a dedicated timer to zero. The UE may increase the timer for every slot until the timer reaches a timing threshold, which may be a predefined or RRC preconfigured value. If the timer has reached the timing threshold and the UE does not receive further indications from the base station on resuming the transmission of SSBs previously refrained by such DCI, the UE may autonomously assume that such refrained transmission of SSBs have already been resumed.

Example aspects presented herein further include mechanisms that aim at reducing impacts of the MAC-CE or DCI based signaling on legacy UEs (e.g., UEs that are not the target of the beam prediction or lack the beam prediction capabilities).

In one configuration, MAC-CE/DCI based signaling may apply exclusively to Non-Cell-Defining SSBs (e.g., SSBs not used for initial cell acquisition, cell identification, or time and frequency synchronization), thereby lessening impacts on UEs attempting initial access via Cell-Defining SSBs.

In another configuration, a certain category of UEs, such as UEs operating under earlier technical specifications or standards, may not be scheduled to monitor the SSBs refrained by the MAC-CE/DCI based signaling for UEs involving the MAC-CE/DCI based signaling. This configuration is beneficial when the network has identified limited or no presence of the certain category UEs in the current cell. Under this configuration, introducing the MAC-CE/DCI based signaling for the refraining or resuming of the transmission of SSBs results in no additional specification impact.

Example aspects presented herein further introduce one or more side conditions for receiving the aforementioned MAC-CE/DCI based signals. In some examples, the UE may receive the MAC-CE/DCI to refrain from transmitting a certain SSB, conditioned on that the UE has identified the SSB as a prediction target resource for channel characteristics prediction procedures. In one configuration, the base station (e.g., a gNB) may configure, activate, or trigger a CSI report to the UE. The contents of the CSI report (e.g., reportQuantity of the CSI report) may include at least predicted channel characteristics, such as Layer-1 reference signal received power (L1-RSRP), Layer-1 signal-to-interference-plus-noise ratio (L1-SINR), the top K strongest beams (“Top-K-Beam”) associated with such a specific SSB, without actually measuring the SSB. The CSI report may be, for example, a pre-coding CSI (P-CSI) report, a scaling/phase CSI (SP-CSI) report, or an amplitude/phase CSI (AP/CSI) report.

In another configuration, the UE may autonomously identify that it may treat a certain SSB as channel characteristics (including L1-RSRP, L1-SINR, Top-K-Beam) prediction target resource, without actually measuring the SSB, and the UE may report such decision back to the base station (e.g., the gNB).

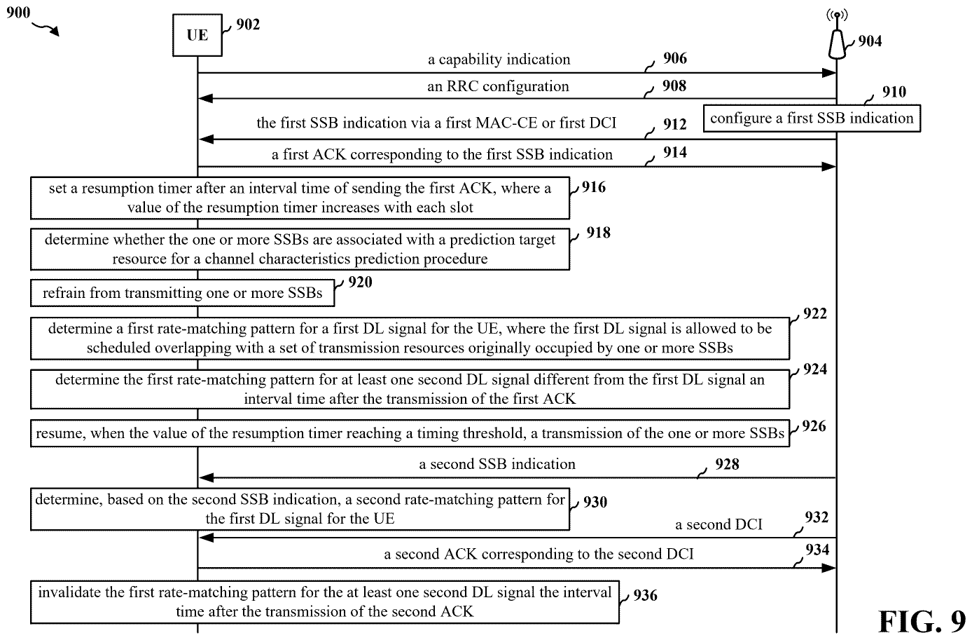

FIG. 9 is a call flow diagram 900 illustrating a method of wireless communication in accordance with various aspects of this present disclosure. Various aspects are described in connection with a UE 902 and a base station 904. The aspects may be performed by the UE 902 or the base station 904 in aggregation and/or by one or more components of a base station 904 (e.g., such as a CU 110, a DU 130, and/or an RU 140).

As shown in FIG. 9, at 906, a UE 902 may transmit a capability indication to the base station 904. The capability indication may indicate a capability of the UE 902 for a beam prediction capability. For example, the beam prediction capability may include one or more of: a general capability of the UE 902 for the reception of MAC-CE-based signaling and DCI-based signaling; a MAC-CE capability of the UE 902 for the reception of the MAC-CE-based signaling; a DCI capability of the UE 902 for the reception of the DCI-based signaling; or an RSRP prediction capability of the UE 902 for predicting an L1 RSRP of SSBs.

At 908, the UE 902 may receive an RRC configuration from the base station 904. The RRC configuration may be based on, for example, an RMSI configuration, or a serving cell configuration (e.g., ServingCellConfigCommon). The RRC configuration may be associated with one or more SSBs. Referring to FIG. 5, the RRC configuration (e.g., ssb-PositionInBurst from an RMSI configuration) may identify a set of actually transmitted SSBs (e.g., SSBs #1-SSB #12).

At 910, the base station 904 may configure a first SSB indication. Referring to FIG. 6A, the first SSB indication may indicate refraining from transmitting certain SSBs (e.g., SSB #7-SSB #12).

At 912, the base station 904 may transmit the first SSB indication to the UE 902. In some examples, the base station 904 may transmit the first SSB indication to the UE 902 via a first MAC-CE or first DCI. Referring to FIG. 7, the base station may transmit the first SSB indication to the UE via the MAC-CE 702.

At 914, the UE 902 may send a first ACK corresponding to the first SSB indication to the base station 904. Referring to FIG. 7, the UE may send a first ACK 704 corresponding to the first SSB indication (e.g., MAC-CE 702) to the base station.

At 916, the UE 902 may set a resumption timer after an interval time of sending the first ACK (at 914). The value of the resumption timer may increase with each slot. Referring to FIG. 7, the UE may set a resumption timer (e.g., timer 710) after an interval time (e.g., X milliseconds) of sending the ACK 704.

At 918, the UE 902 may determine whether the one or more SSBs are associated with a prediction target resource for a channel characteristics prediction procedure.

At 920, the UE 902 may refrain from transmitting the one or more SSBs. For example, referring to FIG. 6A, the UE may refrain from transmitting the one or more SSBs (e.g., SSB #7-SSB #12). In some examples, the UE 902 may refrain from transmitting the one or more SSBs based on the first SSB indication (received at 912). In some examples, the UE 902 may refrain from transmitting the one or more SSBs if, at 918, the one or more SSBs are determined to be associated with the prediction target resource for the channel characteristics prediction procedure.

At 922, the UE 902 may determine, based on the first SSB indication (received at 912), a first rate-matching pattern for a first DL signal for the UE 902. The first DL signal may be allowed to be scheduled overlapping with a set of transmission resources originally occupied by the one or more SSBs. In some examples, the first DL signal may be actually scheduled overlapping with the set of transmission resources originally occupied by the one or more SSBs. For example, referring to FIG. 6A, the first DL signal may be allowed to be scheduled overlapping with a set of transmission resources originally occupied by SSB #7-SSB #12. In some examples, the first DL signal may be actually scheduled overlapping with the set of transmission resources originally occupied by SSB #7-SSB #12.

At 924, the UE 902 may determine the first rate-matching pattern for at least one second DL signal different from the first DL signal an interval time after the transmission of the first ACK (at 914).

At 926, the UE 902 may resume the transmission of the one or more SSBs that were previously refrained from transmitting (at 920) when the value of the resumption timer (which was set by the UE 902 at 916) reaches a timing threshold. For example, referring to FIG. 7, the UE may resume, at t₁, transmitting the one or more SSBs that were previously refrained from transmitting (at t₀) when the value of the timer 710 reaches the timing threshold.

At 928, the base station 904 may transmit a second SSB indication to the UE 902. In some examples, the second SSB may indicate for the UE 902 to resume the transmission of the one or more SSBs that were previously refrained from transmitting (at 920). For example, referring to FIG. 7, the base station may transmit a second SSB indication (e.g., MAC-CE 706) to the UE to indicate the UE to resume the transmission of the one or more SSBs that were previously refrained from transmitting by MAC-CE 702.

At 930, the UE 930 may determine, based on the second SSB indication, a second rate-matching pattern for the first DL signal for the UE. In some examples, in the second rate-matching pattern, the first DL signal may not be allowed to be scheduled overlapping with the set of transmission resources originally occupied by the one or more SSBs.

At 932, the base station 904 may transmit a second DCI to the UE 902.

At 934, the UE 902 may transmit a second ACK corresponding to the second DCI to the base station 904.

At 936, the UE 902 may invalidate the first rate-matching pattern (determined at 922) for the at least one second DL signal the interval time after the transmission of the second ACK (at 934).

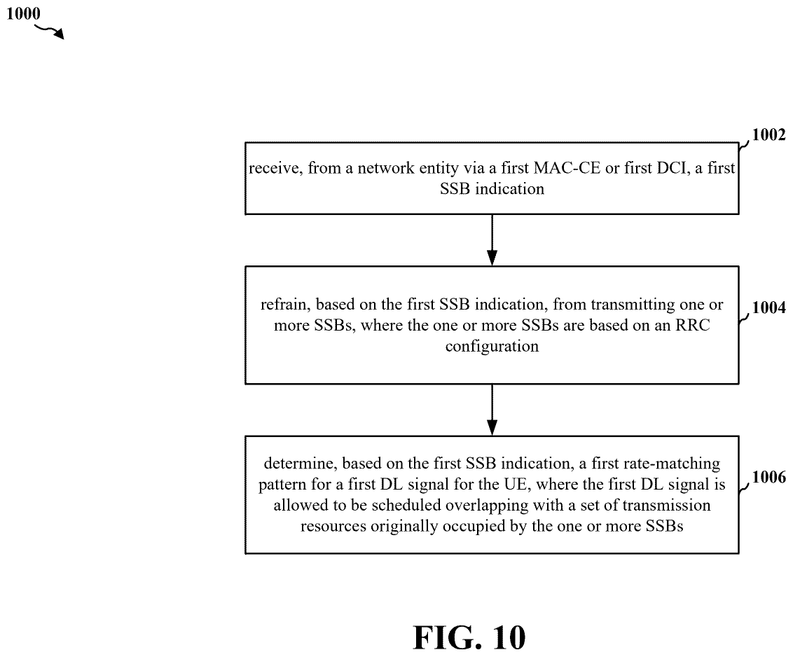

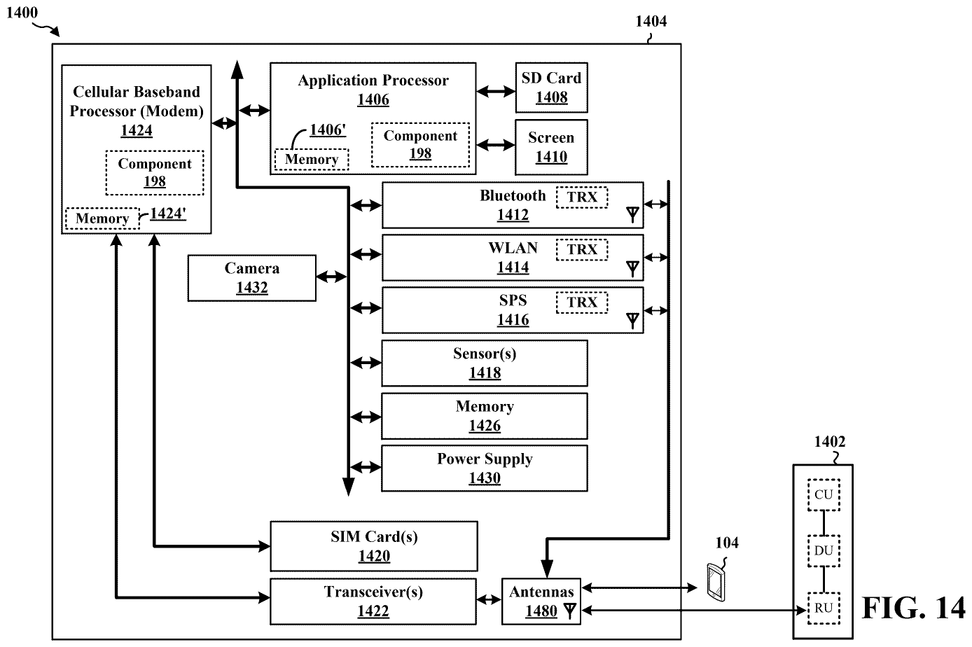

FIG. 10 is a flowchart 1000 illustrating methods of wireless communication at a UE in accordance with various aspects of the present disclosure. The method may be performed by a UE. The UE may be the UE 104, 350, 902, or the apparatus 1404 in the hardware implementation of FIG. 14. Example aspects presented herein enable efficient and dynamic SSB recycling through the use of MAC-CE or DCI signaling. Example aspects improve the efficiency of wireless communication by reducing SSB overhead, enhancing scheduling flexibility, and improving the utilization of transmission resources.

As shown in FIG. 10, at 1002, the UE may receive, from a network entity via a first MAC-CE or first DCI, a first SSB indication. The network entity may be a base station, or a component of a base station, in the access network of FIG. 1 or a core network component (e.g., base station 102, 310, 904; or the network entity 1402 in the hardware implementation of FIG. 14). FIGS. 6A, 6B, 7, 8, and 9 illustrate various aspects of the steps in connection with flowchart 1000. For example, referring to FIG. 9, the UE 902 may receive, at 912, from a network entity (base station 904) via a first MAC-CE or first DCI, a first SSB indication. Referring to FIG. 7, the base station may transmit the first SSB indication to the UE via the MAC-CE 702. In some aspects, 1002 may be performed by the SSB configuration component 198.

At 1004, the UE may refrain, based on the first SSB indication, from transmitting one or more SSBs. The one or more SSBs may be based on an RRC configuration. For example, referring to FIG. 9, the UE 902 may refrain, at 920, based on the first SSB indication (received at 912), from transmitting one or more SSBs. The one or more SSBs may be based on an RRC configuration (received at 908). Referring to FIG. 6A, the UE may refrain from transmitting the one or more SSBs (e.g., SSB #7-SSB #12). In some aspects, 1004 may be performed by the SSB configuration component 198.

At 1006, the UE may determine, based on the first SSB indication, a first rate-matching pattern for a first DL signal for the UE. The first DL signal may be allowed to be scheduled overlapping with a set of transmission resources originally occupied by the one or more SSBs. In some examples, the first DL signal may be actually scheduled overlapping with the set of transmission resources originally occupied by the one or more SSBs. For example, referring to FIG. 9, the UE 902 may determine, at 922, based on the first SSB indication (received at 912), a first rate-matching pattern for a first DL signal for the UE 902. The first DL signal may be allowed to be scheduled overlapping with a set of transmission resources originally occupied by the one or more SSBs. Referring to FIG. 6A, the first DL signal may be allowed to be scheduled overlapping with a set of transmission resources originally occupied by SSB #7-SSB #12. In some examples, the first DL signal may be actually scheduled overlapping with the set of transmission resources originally occupied by SSB #7-SSB #12. In some aspects, 1006 may be performed by the SSB configuration component 198.

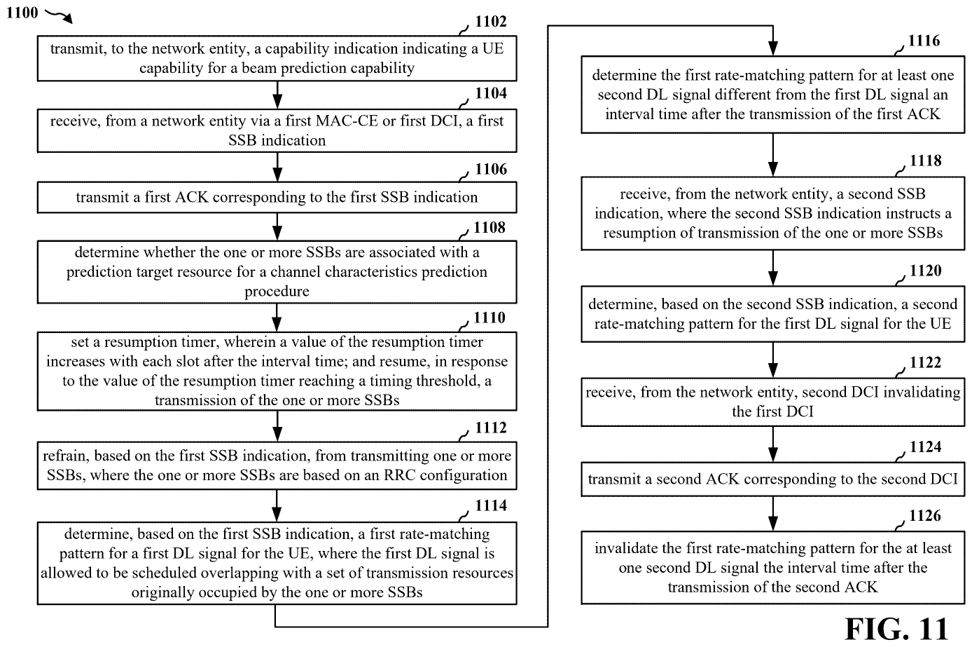

FIG. 11 is a flowchart 1100 illustrating methods of wireless communication at a UE in accordance with various aspects of the present disclosure. The method may be performed by a UE. The UE may be the UE 104, 350, 902, or the apparatus 1404 in the hardware implementation of FIG. 14. Example aspects presented herein enable efficient and dynamic SSB recycling through the use of MAC-CE or DCI signaling. Example aspects improve the efficiency of wireless communication by reducing SSB overhead, enhancing scheduling flexibility, and improving the utilization of transmission resources.

As shown in FIG. 11, at 1104, the UE may receive, from a network entity via a first MAC-CE or first DCI, a first SSB indication. The network entity may be a base station, or a component of a base station, in the access network of FIG. 1 or a core network component (e.g., base station 102, 310, 904; or the network entity 1402 in the hardware implementation of FIG. 14). FIGS. 6A, 6B, 7, 8, and 9 illustrate various aspects of the steps in connection with flowchart 1100. For example, referring to FIG. 9, the UE 902 may receive, at 912, from a network entity (base station 904) via a first MAC-CE or first DCI, a first SSB indication. Referring to FIG. 7, the base station may transmit the first SSB indication to the UE via the MAC-CE 702. In some aspects, 1104 may be performed by the SSB configuration component 198.

At 1112, the UE may refrain, based on the first SSB indication, from transmitting one or more SSBs. The one or more SSBs may be based on an RRC configuration. For example, referring to FIG. 9, the UE 902 may refrain, at 920, based on the first SSB indication (received at 912), from transmitting one or more SSBs. The one or more SSBs may be based on an RRC configuration (received at 908). Referring to FIG. 6A, the UE may refrain from transmitting the one or more SSBs (e.g., SSB #7-SSB #12). In some aspects, 1112 may be performed by the SSB configuration component 198.

At 1114, the UE may determine, based on the first SSB indication, a first rate-matching pattern for a first DL signal for the UE. The first DL signal is allowed to be scheduled overlapping with a set of transmission resources originally occupied by the one or more SSBs. In some examples, the first DL signal may be actually scheduled overlapping with the set of transmission resources originally occupied by the one or more SSBs. For example, referring to FIG. 9, the UE 902 may determine, at 922, based on the first SSB indication (received at 912), a first rate-matching pattern for a first DL signal for the UE 902. The first DL signal is allowed to be scheduled overlapping with a set of transmission resources originally occupied by the one or more SSBs. Referring to FIG. 6A, the first DL signal is allowed to be scheduled overlapping with a set of transmission resources originally occupied by SSB #7-SSB #12. In some examples, the first DL signal may be actually scheduled overlapping with the set of transmission resources originally occupied by SSB #7-SSB #12. In some aspects, 1114 may be performed by the SSB configuration component 198.

In some aspects, the RRC configuration may be based on one of: an RMSI configuration, or other RRC configurations, such as a serving cell configuration (e.g., ServingCellConfigCommon) or a configuration associated with SSB Machine Type Communication (MTC) (e.g., SSB-MTC-AdditionalPCI-r17). For example, referring to FIG. 9, the RRC configuration (received at 908) may be based on one of: an RMSI configuration, or other RRC configurations. The other RRC configuration may be, for example, a serving cell configuration (e.g., ServingCellConfigCommon) or a configuration associated with SSB Machine Type Communication (MTC) (e.g., SSB-MTC-AdditionalPCI-r17).

In some aspects, at 1102, the UE may transmit, to the network entity, a capability indication indicating a UE capability for a beam prediction capability. The reception of the first SSB indication may be in response to the UE capability for the beam prediction capability. For example, referring to FIG. 9, the UE 902 may transmit, at 906, to the network entity (base station 904), a capability indication indicating a UE capability for a beam prediction capability. The reception of the first SSB indication (at 912) may be in response to the UE capability for the beam prediction capability. In some aspects, 1102 may be performed by the SSB configuration component 198.

In some aspects, the beam prediction capability may include one or more of: a general capability of the UE for the reception of MAC-CE-based signaling and DCI-based signaling; a MAC-CE capability of the UE for the reception of the MAC-CE-based signaling; a DCI capability of the UE for the reception of the DCI-based signaling; or an RSRP prediction capability of the UE for predicting an L1 RSRP of SSBs. For example, referring to FIG. 9, the beam prediction capability (indicated by the capability indication at 906) may include one or more of: a general capability of the UE 902 for the reception of MAC-CE-based signaling and DCI-based signaling; a MAC-CE capability of the UE 902 for the reception of the MAC-CE-based signaling; a DCI capability of the UE 902 for the reception of the DCI-based signaling; or an RSRP prediction capability of the UE 902 for predicting an L1 RSRP of SSBs.

In some aspects, the first DL signal may include one or more of: a PDSCH, a PDCCH, or a CSI-RS. For example, referring to FIG. 9, the first DL signal (at 922) may include one or more of: a PDSCH, a PDCCH, or a CSI-RS.

In some aspects, the set of transmission resources may include a time domain transmission resource and a frequency domain transmission resource. For example, referring to FIG. 6A, the set of transmission resources may include the time domain transmission resource and the frequency domain transmission resource originally occupied by the one or more SSBs (e.g., SSB #7-SSB #12).

In some aspects, at 1118, the UE may receive, from the network entity, a second SSB indication. The second SSB indication may instruct a resumption of transmission of the one or more SSBs. In some aspects, at 1120, the UE may determine, based on the second SSB indication, a second rate-matching pattern for the first DL signal for the UE. For example, referring to FIG. 9, the UE 902 may receive, at 928, from the network entity (base station 904), a second SSB indication. The second SSB indication may instruct a resumption of transmission of the one or more SSBs. At 930, the UE 902 may determine, based on the second SSB indication (received at 928), a second rate-matching pattern for the first DL signal for the UE 902. Referring to FIG. 7, the base station may transmit a second SSB indication (e.g., MAC-CE 706) to the UE to indicate the UE to resume the transmission of the one or more SSBs that were previously refrained from transmitting by MAC-CE 702. In some aspects, 1118 and 1120 may each be performed by the SSB configuration component 198.

In some aspects, to determine the second rate-matching pattern for the first DL signal for the UE, the UE may determine the second rate-matching pattern for the first DL signal. The first DL signal is not allowed to be scheduled overlapping with the set of transmission resources originally occupied by the one or more SSBs. For example, referring to FIG. 6B, the first DL signal may not be allowed to be scheduled overlapping with the set of transmission resources originally occupied by the one or more SSBs (e.g., SSB #7-SSB #12).

In some aspects, at 1106, the UE may transmit a first ACK corresponding to the first SSB indication. The first rate-matching pattern may be applied an interval time after the transmission of the first ACK. For example, referring to FIG. 9, the UE 902 may transmit, at 914, a first ACK corresponding to the first SSB indication. The first rate-matching pattern (at 922) may be applied an interval time after the transmission of the first ACK. Referring to FIG. 7, the UE may send a first ACK 704 corresponding to the first SSB indication (e.g., MAC-CE 702) to the base station, and the first rate-matching pattern may be applied an interval time (e.g., X milliseconds) after the transmission of the first ACK 704. In some aspects, 1106 may be performed by the SSB configuration component 198.

In some aspects, at 1110, the UE may, after the interval time after transmitting the first ACK: set a resumption timer, where the value of the resumption timer increases with each slot after the interval time; and resume, in response the value of the resumption timer reaching a timing threshold, a transmission of the one or more SSBs. For example, referring to FIG. 9, the UE 902 may, at 916, after the interval time after transmitting the first ACK (at 914), set a resumption timer. The value of the resumption timer may increase with each slot after the interval time. The UE 902 may resume, at 926, in response the value of the resumption timer reaching a timing threshold, the transmission of the one or more SSBs. Referring to FIG. 7, the UE may, after the interval time (e.g., X milliseconds) after transmitting the first ACK 704: set a resumption timer (e.g., timer 710). The value of the resumption timer increases with each slot after the interval time (e.g., X milliseconds). The UE may resume, in response the value of the resumption timer reaching a timing threshold (at t₁), a transmission of the one or more SSBs. In some aspects, 1110 may be performed by the SSB configuration component 198.

In some aspects, to receive the first SSB indication (at 1104), the UE may receive the first SSB indication via the first MAC-CE, and the first MAC-CE includes at least one of: a service cell ID identifying a service cell, or a BWP identifier identifying a bandwidth. The first SSB indication may be applied to at least one of the service cell or the bandwidth. For example, referring to FIG. 9, to receive the first SSB indication (at 912), the UE 902 may receive the first SSB indication via the first MAC-CE, and the first MAC-CE may include at least one of: a service cell ID identifying a service cell, or a BWP identifier identifying a bandwidth. The first SSB indication may be applied to at least one of the service cell or the bandwidth.

In some aspects, to receive the first SSB indication (at 1104), the UE may receive the first SSB indication via the first DCI, and the UE may further identify a set of candidate SSBs based on at least one of an RRC configuration and a MAC-CE configuration, and the first DCI may identify the one or more SSBs from the set of candidate SSBs. For example, referring to FIG. 9, to receive the first SSB indication (at 912), the UE 902 may receive the first SSB indication via the first DCI, and the UE 902 may further identify a set of candidate SSBs based on at least one of an RRC configuration and a MAC-CE configuration, and the first DCI may identify the one or more SSBs from the set of candidate SSBs. Referring to FIG. 8, the UE may further identify a set of candidate SSBs based on at least one of an RRC configuration (at 802) and a MAC-CE configuration (at 804), and the first DCI may identify, at 808, the one or more SSBs from the set of candidate SSBs.

In some aspects, to refrain (at 1112) from transmitting the one or more SSBs, the UE may refrain, in response to the one or more SSBs being associated with the PDSCH scheduled by the first DCI, from transmitting the one or more SSBs. For example, referring to FIG. 9, to refrain from transmitting the one or more SSBs (at 920), the UE 902 may refrain, in response to the one or more SSBs being associated with the PDSCH scheduled by the first DCI, from transmitting the one or more SSBs. Referring to FIG. 8, the UE may refrain, in response to the one or more SSBs being associated with the PDSCH scheduled by the first DCI (at 810), from transmitting the one or more SSBs.

In some aspects, the UE may transmit, at 1106, a first ACK corresponding to the first SSB indication; and, at 1116, determine the first rate-matching pattern for at least one second DL signal different from the first DL signal an interval time after the transmission of the first ACK. For example, referring to FIG. 9, the UE 902 may transmit, at 914, a first ACK corresponding to the first SSB indication. The UE 902 may determine, at 924, the first rate-matching pattern for at least one second DL signal different from the first DL signal an interval time after the transmission of the first ACK. In some aspects, the at least one second DL signal may be allowed to be scheduled overlapping with the set of transmission resources originally occupied by the one or more SSBs. In some examples, the at least one second DL signal may be actually scheduled overlapping with the set of transmission resources originally occupied by the one or more SSBs. In some aspects, 1116 may be performed by the SSB configuration component 198.

In some aspects, the UE may receive, at 1122, from the network entity, second DCI invalidating the first DCI. The UE may further transmit, at 1124, a second ACK corresponding to the second DCI, and, at 1126, invalidate the first rate-matching pattern for the at least one second DL signal the interval time after the transmission of the second ACK. For example, referring to FIG. 9, the UE 902 may receive, at 932, from the network entity (base station 904), second DCI. The second DCI may invalidate the first DCI. The UE 902 may further transmit, at 934, a second ACK corresponding to the second DCI. At 936, the UE 902 may invalidate the first rate-matching pattern for the at least one second DL signal the interval time after the transmission of the second ACK. In some aspects, 1122, 1124 and 1126 may each be performed by the SSB configuration component 198.

In some aspects, to refrain (at 1112) from transmitting the one or more SSBs, the UE may refrain, in response to the one or more SSBs not defining a cell, transmitting the one or more SSBs. For example, referring to FIG. 9, to refrain from transmitting the one or more SSBs (at 920), the UE 902 may refrain, in response to the one or more SSBs not defining a cell, transmitting the one or more SSBs.

In some aspects, the UE may be a first UE, and the UE may refrain from scheduling a second UE for monitoring the one or more SSBs.

In some aspects, the UE may determine, at 1108, whether the one or more SSBs are associated with a prediction target resource for a channel characteristics prediction procedure, and to refrain (at 1112) from transmitting the one or more SSBs, the UE may refrain, in response to the one or more SSBs being associated with the prediction target resource for the channel characteristics prediction procedure, from transmitting the one or more SSBs. For example, referring to FIG. 9, the UE 902 may determine, at 9 18, whether the one or more SSBs are associated with a prediction target resource for a channel characteristics prediction procedure. To refrain from transmitting the one or more SSBs (at 920), the UE 902 may refrain, in response to the one or more SSBs being associated with the prediction target resource for the channel characteristics prediction procedure, from transmitting the one or more SSBs.

In some aspects, to determine whether the one or more SSBs are associated with the prediction target resource for the channel characteristics prediction procedure, the UE may receive, from the network entity, a CSI report; and determine, based on the CSI report, whether the one or more SSBs are associated with the prediction target resource for the channel characteristics prediction procedure. For example, referring to FIG. 9, to determine whether the one or more SSBs are associated with the prediction target resource for the channel characteristics prediction procedure at 918, the UE 902 may receive, from the network entity (base station 904), a CSI report, and determine, based on the CSI report, whether the one or more SSBs are associated with the prediction target resource for the channel characteristics prediction procedure.

In some aspects, to determine whether the one or more SSBs are associated with the prediction target resource for the channel characteristics prediction procedure, the UE may autonomously determine that the one or more SSBs are associated with the prediction target resource for the channel characteristics prediction procedure; and transmit, to the network entity, an indication of the autonomous determination. For example, referring to FIG. 9, to determine whether the one or more SSBs are associated with the prediction target resource for the channel characteristics prediction procedure at 918, the UE 902 may autonomously determine that the one or more SSBs are associated with the prediction target resource for the channel characteristics prediction procedure; and transmit, to the network entity (base station 904), an indication of the autonomous determination.

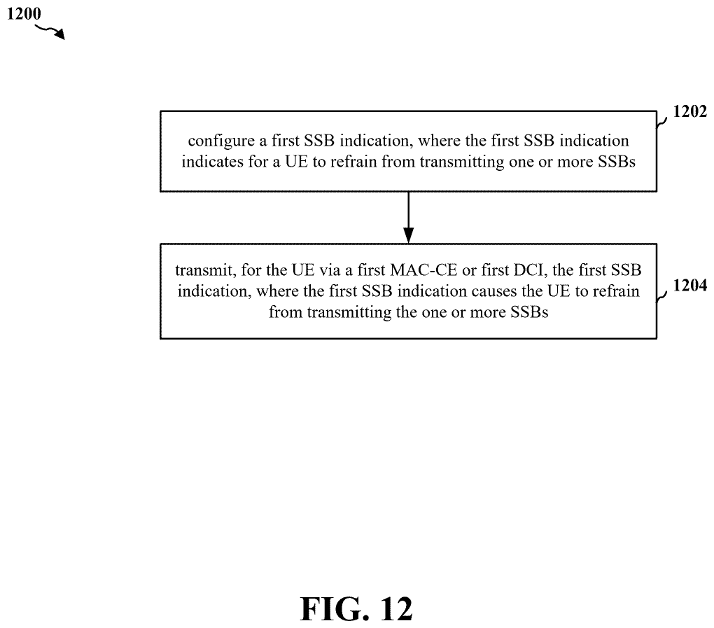

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 904; or the network entity 1402 in the hardware implementation of FIG. 14). Example aspects presented herein enable efficient and dynamic SSB recycling through the use of MAC-CE or DCI signaling. Example aspects improve the efficiency of wireless communication by reducing SSB overhead, enhancing scheduling flexibility, and improving the utilization of transmission resources.

As shown in FIG. 12, at 1202, the network entity may configure a first SSB indication. The first SSB indication may indicate for a UE to refrain from transmitting one or more SSBs. The UE may be the UE 104, 350, 902, or the apparatus 1404 in the hardware implementation of FIG. 14. FIGS. 6A, 6B, 7, 8, and 9 illustrate various aspects of the steps in connection with flowchart 1200. For example, referring to FIG. 9, the network entity (base station 904) may configure, at 910, a first SSB indication. The first SSB indication may indicate for a UE 902 to refrain from transmitting one or more SSBs (at 920). Referring to FIG. 6A, the first SSB indication may indicate refraining from transmitting certain SSBs (e.g., SSB #7-SSB #12). In some aspects, 1202 may be performed by the SSB configuration component 199.

At 1204, the network entity may transmit, for the UE via a first MAC-CE or first DCI, the first SSB indication. The first SSB indication may cause the UE to refrain from transmitting the one or more SSBs. For example, referring to FIG. 9, the network entity (base station 904) may transmit, at 912, for the UE 902 via a first MAC-CE or first DCI, the first SSB indication. The first SSB indication may cause the UE 902 to refrain from transmitting the one or more SSBs (at 920). Referring to FIG. 7, the base station may transmit the first SSB indication to the UE via the MAC-CE 702. In some aspects, 1204 may be performed by the SSB configuration component 199.

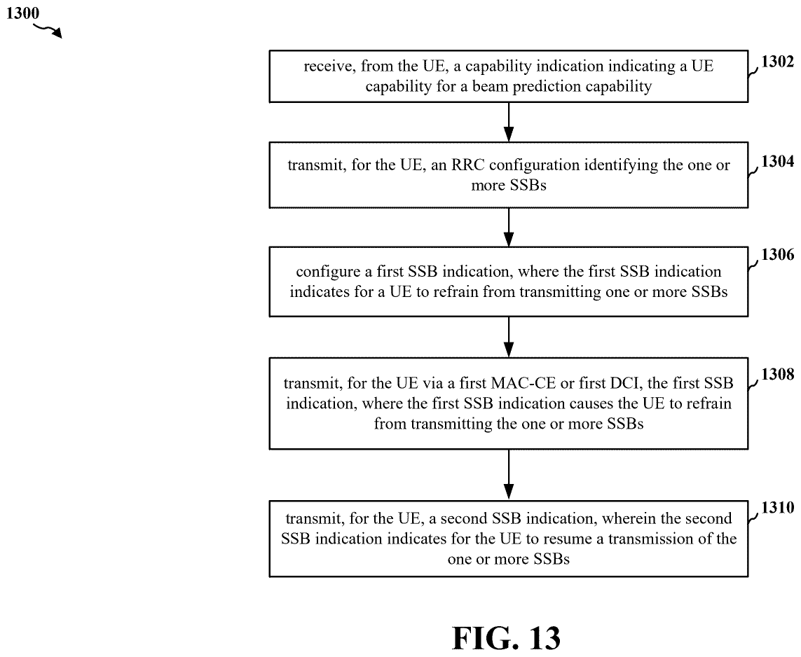

FIG. 13 is a flowchart 1300 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 904; or the network entity 1402 in the hardware implementation of FIG. 14). Example aspects presented herein enable efficient and dynamic SSB recycling through the use of MAC-CE or DCI signaling. Example aspects improve the efficiency of wireless communication by reducing SSB overhead, enhancing scheduling flexibility, and improving the utilization of transmission resources.

As shown in FIG. 13, at 1306, the network entity may configure a first SSB indication. The first SSB indication may indicate for a UE to refrain from transmitting one or more SSBs. The UE may be the UE 104, 350, 902, or the apparatus 1404 in the hardware implementation of FIG. 14. FIGS. 6A, 6B, 7, 8, and 9 illustrate various aspects of the steps in connection with flowchart 1300. For example, referring to FIG. 9, the network entity (base station 904) may configure, at 910, a first SSB indication. The first SSB indication may indicate for a UE 902 to refrain from transmitting one or more SSBs (at 920). Referring to FIG. 6A, the first SSB indication may indicate refraining from transmitting certain SSBs (e.g., SSB #7-SSB #12). In some aspects, 1306 may be performed by the SSB configuration component 199.

At 1308, the network entity may transmit, for the UE via a first MAC-CE or first DCI, the first SSB indication. The first SSB indication may cause the UE to refrain from transmitting the one or more SSBs. For example, referring to FIG. 9, the network entity (base station 904) may transmit, at 912, for the UE 902 via a first MAC-CE or first DCI, the first SSB indication. The first SSB indication may cause the UE 902 to refrain from transmitting the one or more SSBs (at 920). Referring to FIG. 7, the base station may transmit the first SSB indication to the UE via the MAC-CE 702. In some aspects, 1308 may be performed by the SSB configuration component 199.

In some aspects, at 1304, the network entity may transmit, for the UE, an RRC configuration identifying the one or more SSBs. The RRC configuration is based on one of: a remaining minimum system information (RMSI) configuration, or other RRC configurations, such as a serving cell configuration (e.g., ServingCellConfigCommon) or a configuration associated with SSB Machine Type Communication (MTC) (e.g., SSB-MTC-AdditionalPCI-r17). For example, referring to FIG. 9, the network entity (base station 904) may transmit, at 908, for the UE 902, an RRC configuration identifying the one or more SSBs. The RRC configuration may be based on one of: an RMSI configuration, or other RRC configurations, such as a serving cell configuration (e.g., ServingCellConfigCommon) or a configuration associated with SSB Machine Type Communication (MTC) (e.g., SSB-MTC-AdditionalPCI-r17). In some aspects, 1304 may be performed by the SSB configuration component 199.

In some aspects, at 1302, the network entity may receive, from the UE, a capability indication indicating a UE capability for a beam prediction capability. To transmit the first SSB indication (at 1304), the network entity may transmit, in response to the UE capability for the beam prediction capability, the first SSB indication. For example, referring to FIG. 9, the network entity (base station 904) may receive, at 906, from the UE 902, a capability indication. The capability indication may indicate a UE capability for a beam prediction capability. To transmit the first SSB indication (at 912), the network entity (base station 904) may transmit, at 912, in response to the UE capability for the beam prediction capability, the first SSB indication. In some aspects, 1302 may be performed by the SSB configuration component 199.

In some aspects, the beam prediction capability may include one or more of: a general capability of the UE for the reception of MAC-CE-based signaling and DCI-based signaling; a MAC-CE capability of the UE for the reception of the MAC-CE-based signaling; a DCI capability of the UE for the reception of the DCI-based signaling; or an RSRP prediction capability of the UE for predicting an L1 RSRP of SSBs. For example, referring to FIG. 9, the beam prediction capability (indicated by the capability indication at 906) may include one or more of: a general capability of the UE 902 for the reception of MAC-CE-based signaling and DCI-based signaling; a MAC-CE capability of the UE 902 for the reception of the MAC-CE-based signaling; a DCI capability of the UE 902 for the reception of the DCI-based signaling; or an RSRP prediction capability of the UE 902 for predicting an L1 RSRP of SSBs.

In some aspects, at 1310, the network entity may transmit, for the UE, a second SSB indication. The second SSB indication may indicate for the UE to resume the transmission of the one or more SSBs. For example, referring to FIG. 9, the network entity (base station 904) may transmit, at 928, for the UE 902, a second SSB indication. The second SSB indication may indicate for the UE 902 to resume the transmission of the one or more SSBs. In some aspects, 1310 may be performed by the SSB configuration component 199.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to receive, from a network entity via a first MAC-CE or first DCI, a first SSB indication; refrain, based on the first SSB indication, from transmitting one or more SSBs, where the one or more SSBs are based on an RRC configuration; and determine, based on the first SSB indication, a first rate-matching pattern for a first DL signal for the UE, where the first DL signal is allowed to be scheduled overlapping with a set of transmission resources originally occupied by the one or more SSBs. The component 198 may be further configured to perform any of the aspects described in connection with the flowcharts in FIG. 10 and FIG. 11, and/or performed by the UE 902 in FIG. 9. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, includes means for receiving, from a network entity via a first MAC-CE or first DCI, a first SSB indication, means for refraining, based on the first SSB indication, from transmitting one or more SSBs, where the one or more SSBs are based on an RRC configuration, and means for determining, based on the first SSB indication, a first rate-matching pattern for a first DL signal for the UE, where the first DL signal is allowed to be scheduled overlapping with a set of transmission resources originally occupied by the one or more SSBs. The apparatus 1404 may further include means for performing any of the aspects described in connection with the flowcharts in FIG. 10 and FIG. 11, and/or aspects performed by the UE 902 in FIG. 9. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

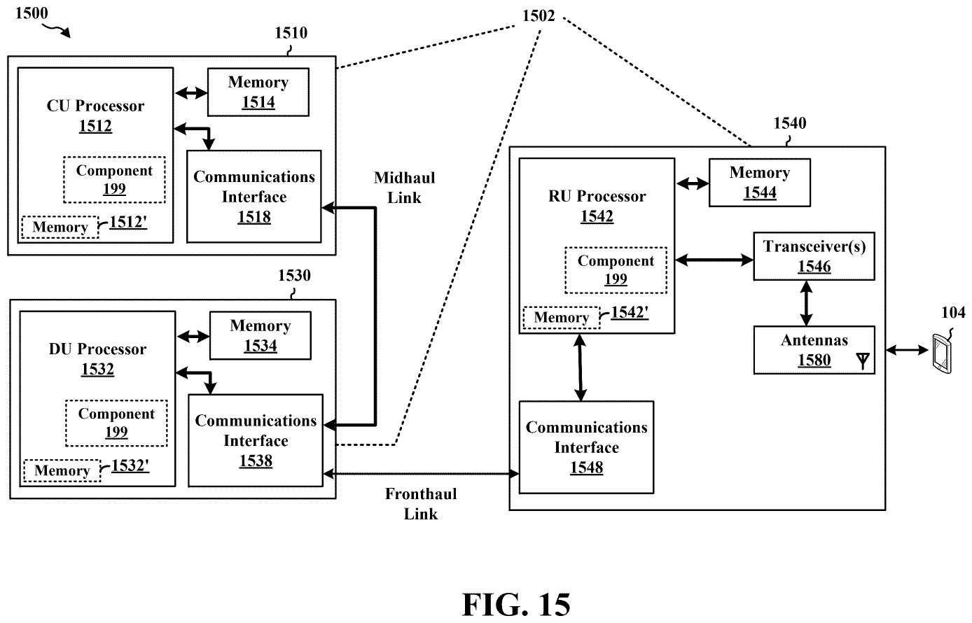

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a first SSB indication, where the first SSB indication indicates for a UE to refrain from transmitting one or more SSBs; and transmit, for the UE via a first MAC-CE or first DCI, the first SSB indication, where the first SSB indication causes the UE to refrain from transmitting the one or more SSBs. The component 199 may be further configured to perform any of the aspects described in connection with the flowcharts in FIG. 12 and FIG. 13, and/or performed by the base station 904 in FIG. 9. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for configuring a first SSB indication, where the first SSB indication indicates for a UE to refrain from transmitting one or more SSBs, and means for transmitting, for the UE via a first MAC-CE or first DCI, the first SSB indication, where the first SSB indication causes the UE to refrain from transmitting the one or more SSBs. The network entity 1502 may further include means for performing any of the aspects described in connection with the flowcharts in FIG. 12 and FIG. 13, and/or aspects performed by the base station 904 in FIG. 9. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity via a first MAC-CE or first DCI, a first SSB indication; refraining, based on the first SSB indication, from transmitting one or more SSBs, where the one or more SSBs are based on an RRC configuration; and determining, based on the first SSB indication, a first rate-matching pattern for a first DL signal for the UE, where the first DL signal is allowed to be scheduled overlapping with a set of transmission resources originally occupied by the one or more SSBs. Example aspects presented herein enable efficient and dynamic SSB recycling through the use of MAC-CE or DCI signaling. Example aspects improve the efficiency of wireless communication by reducing SSB overhead, enhancing scheduling flexibility, and improving the utilization of transmission resources.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving, from a network entity via a first medium access control (MAC)-control element (MAC-CE) or first downlink control information (DCI), a first synchronization signal block (SSB) indication; refraining, based on the first SSB indication, from transmitting one or more SSBs, wherein the one or more SSBs are based on a radio resource control (RRC) configuration; and determining, based on the first SSB indication, a first rate-matching pattern for a first DL signal for the UE, wherein the first DL signal is allowed to be scheduled overlapping with a set of transmission resources originally occupied by the one or more SSBs.

Aspect 2 is the method of aspect 1, wherein the RRC configuration may be based on one of: a remaining minimum system information (RMSI) configuration, or a serving cell configuration.

Aspect 3 is the method of any of aspects 1 to 2, where the method may further comprise: transmitting, to the network entity, a capability indication indicating a UE capability for a beam prediction capability, and wherein reception of the first SSB indication is in response to the UE capability for the beam prediction capability.

Aspect 4 is the method of aspect 3, wherein the beam prediction capability may comprise one or more of: a general capability of the UE for the reception of MAC-CE-based signaling and DCI-based signaling; a MAC-CE capability of the UE for the reception of the MAC-CE-based signaling; a DCI capability of the UE for the reception of the DCI-based signaling; or a reference signal received power (RSRP) prediction capability of the UE for predicting a layer 1 (L1) RSRP of SSBs.

Aspect 5 is the method of any of aspects 1 to 4, wherein the first DL signal may comprise one or more of: a physical downlink shared channel (PDSCH), a physical downlink control channel (PDCCH), or a channel state information reference signal (CSI-RS).

Aspect 6 is the method of aspect 5, wherein the set of transmission resources may comprise a time domain transmission resource and a frequency domain transmission resource.

Aspect 7 is the method of aspect 5, wherein the method may further comprise: receiving, from the network entity, a second SSB indication, wherein the second SSB indication instructs a resumption of transmission of the one or more SSBs; and determining, based on the second SSB indication, a second rate-matching pattern for the first DL signal for the UE.

Aspect 8 is the method of aspect 7, wherein determining the second rate-matching pattern for the first DL signal for the UE may comprise: determining the second rate-matching pattern for the first DL signal, wherein the first DL signal is not allowed to be scheduled overlapping with the set of transmission resources originally occupied by the one or more SSBs.

Aspect 9 is the method of any of aspects 1 to 5, wherein the method may further comprise: transmitting a first acknowledge (ACK) corresponding to the first SSB indication, wherein the first rate-matching pattern is applied an interval time after the transmission of the first ACK.

Aspect 10 is the method of aspect 9, wherein the method may further comprise: after the interval time after the transmission of the first ACK: setting a resumption timer, wherein a value of the resumption timer increases with each slot after the interval time; and resuming, in response the value of the resumption timer reaching a timing threshold, a transmission of the one or more SSBs.

Aspect 11 is the method of any of aspects 1 to 5, wherein receiving the first SSB indication may comprise receiving the first SSB indication via the first MAC-CE, and wherein the first MAC-CE includes at least one of: a service cell identifier (ID) identifying a service cell, or a bandwidth part (BWP) identifier identifying a bandwidth, and wherein the first SSB indication is applied to at least one of the service cell or the bandwidth.

Aspect 12 is the method of any of aspects 1 to 5, wherein receiving the first SSB indication may comprise receiving the first SSB indication via the first DCI, and wherein the method may further comprise: identifying a set of candidate SSBs based on at least one of an RRC configuration and a MAC-CE configuration, and wherein the first DCI identifies the one or more SSBs from the set of candidate SSBs.

Aspect 13 is the method of aspect 12, wherein refraining from transmitting the one or more SSBs may comprise: refraining, in response to the one or more SSBs being associated with the PDSCH scheduled by the first DCI, from transmitting the one or more SSBs.

Aspect 14 is the method of aspect 12, wherein the method may further comprise: transmitting a first acknowledge (ACK) corresponding to the first SSB indication; and determining the first rate-matching pattern for at least one second DL signal different from the first DL signal an interval time after the transmission of the first ACK.

Aspect 15 is the method of aspect 14, wherein the method may further comprise: receiving, from the network entity, second DCI invalidating the first DCI; transmitting a second ACK corresponding to the second DCI; and invalidating the first rate-matching pattern for the at least one second DL signal the interval time after the transmission of the second ACK.

Aspect 16 is the method of aspect 1, wherein refraining from transmitting the one or more SSBs may comprise: refraining, in response to the one or more SSBs not defining a cell, transmitting the one or more SSBs.

Aspect 17 is the method of any of aspects 1 to 16, wherein the UE is a first UE, and the method may further comprise: refraining from scheduling a second UE for monitoring the one or more SSBs.

Aspect 18 is the method of any of aspects 1 to 12, wherein the method may further comprise: determining whether the one or more SSBs are associated with a prediction target resource for a channel characteristics prediction procedure, and wherein refraining from transmitting the one or more SSBs may comprise: refraining, in response to the one or more SSBs being associated with the prediction target resource for the channel characteristics prediction procedure, from transmitting the one or more SSBs.

Aspect 19 is the method of aspect 18, wherein determining whether the one or more SSBs are associated with the prediction target resource for the channel characteristics prediction procedure may comprise: receiving, from the network entity, a channel state information (CSI) report; and determining, based on the CSI report, whether the one or more SSBs are associated with the prediction target resource for the channel characteristics prediction procedure.

Aspect 20 is the method of aspect 18, wherein determining whether the one or more SSBs are associated with the prediction target resource for the channel characteristics prediction procedure may comprise: autonomously determining that the one or more SSBs are associated with the prediction target resource for the channel characteristics prediction procedure; and transmitting, to the network entity, an indication of the autonomous determination.

Aspect 21 is an apparatus for wireless communication at a UE, including: at least one memory; and at least one processor coupled to the at least one memory and, based at least in part on information stored in the at least one memory, the at least one processor, individually or in any combination, is configured to perform the method of any of aspects 1-20.

Aspect 22 is the apparatus of aspect 21, further including at least one of a transceiver or an antenna coupled to the at least one processor and configured to receive the first SSB indication.

Aspect 23 is an apparatus for wireless communication including means for implementing the method of any of aspects 1-20.

Aspect 24 is a computer-readable medium (e.g., a non-transitory computer-readable medium) storing computer executable code, where the code when executed by at least one processor causes the at least one processor, individually or in any combination, to implement the method of any of aspects 1-20.

Aspect 25 is a method of wireless communication at a network entity. The method may include configuring a first synchronization signal block (SSB) indication, wherein the first SSB indication indicates for a user equipment (UE) to refrain from transmitting one or more SSBs; and transmitting, for the UE via a first medium access control (MAC)-control element (MAC-CE) or first downlink control information (DCI), the first SSB indication, wherein the first SSB indication causes the UE to refrain from transmitting the one or more SSBs.

Aspect 26 is the method of aspect 25, wherein the method may further comprise: transmitting, for the UE, a radio resource control (RRC) configuration identifying the one or more SSBs, wherein the RRC configuration is based on one of: a remaining minimum system information (RMSI) configuration, or a serving cell configuration.

Aspect 27 is the method of any of aspects 25 to 26, wherein the method may further comprise: receiving, from the UE, a capability indication indicating a UE capability for a beam prediction capability, and wherein transmitting the first SSB indication may comprise: transmitting, in response to the UE capability for the beam prediction capability, the first SSB indication.

Aspect 28 is the method of aspect 27, wherein the beam prediction capability may comprise one or more of: a general capability of the UE for the reception of MAC-CE-based signaling and DCI-based signaling; a MAC-CE capability of the UE for the reception of the MAC-CE-based signaling; a DCI capability of the UE for the reception of the DCI-based signaling; or a reference signal received power (RSRP) prediction capability of the UE for predicting a layer 1 (L1) RSRP of SSBs.

Aspect 29 is the method of any of aspects 25 to 28, wherein the method may further comprise: transmitting, for the UE, a second SSB indication, wherein the second SSB indication may indicate for the UE to resume the transmission of the one or more SSBs.

Aspect 30 is an apparatus for wireless communication at a network entity, including: at least one memory; and at least one processor coupled to the at least one memory and, based at least in part on information stored in the at least one memory, the at least one processor, individually or in any combination, is configured to perform the method of any of aspects 25-29.

Aspect 31 is the apparatus of aspect 30, further including at least one of a transceiver or an antenna coupled to the at least one processor and configured to transmit the first SSB indication.

Aspect 32 is an apparatus for wireless communication including means for implementing the method of any of aspects 25-29.

Aspect 33 is a computer-readable medium (e.g., a non-transitory computer-readable medium) storing computer executable code, where the code when executed by at least one processor causes the at least one processor, individually or in any combination, to implement the method of any of aspects 25-29.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network entity via a first medium access control (MAC)-control element (MAC-CE) or first downlink control information (DCI), a first synchronization signal block (SSB) indication;
refrain, based on the first SSB indication, from transmitting one or more SSBs, wherein the one or more SSBs are based on a radio resource control (RRC) configuration; and
determine, based on the first SSB indication, a first rate-matching pattern for a first DL signal for the UE, wherein the first DL signal is allowed to be scheduled overlapping with a set of transmission resources originally occupied by the one or more SSBs.

2. The apparatus of claim 1, further comprising a transceiver coupled to the at least one processor, wherein, to receive the first SSB indication, the at least one processor, individually or in any combination, is configured to receive the first SSB indication via the transceiver, and wherein the RRC configuration is based on one of:
a remaining minimum system information (RMSI) configuration, or
a serving cell configuration.

3. The apparatus of claim 1, wherein the at least one processor, individually or in any combination, is further configured to:
transmit, to the network entity, a capability indication indicating a UE capability for a beam prediction capability, and wherein reception of the first SSB indication is in response to the UE capability for the beam prediction capability.

4. The apparatus of claim 3, wherein the beam prediction capability comprises one or more of:
a general capability of the UE for reception of MAC-CE-based signaling and DCI-based signaling;
a MAC-CE capability of the UE for the reception of the MAC-CE-based signaling;
a DCI capability of the UE for the reception of the DCI-based signaling; or
a reference signal received power (RSRP) prediction capability of the UE for predicting a layer 1 (L1) RSRP of SSBs.

5. The apparatus of claim 1, wherein the first DL signal comprises one or more of:
a physical downlink shared channel (PDSCH),
a physical downlink control channel (PDCCH), or
a channel state information reference signal (CSI-RS).

6. The apparatus of claim 5, wherein the set of transmission resources comprises a time domain transmission resource and a frequency domain transmission resource.

7. The apparatus of claim 5, wherein the at least one processor, individually or in any combination, is further configured to:
receive, from the network entity, a second SSB indication, wherein the second SSB indication instructs a resumption of transmission of the one or more SSBs; and
determine, based on the second SSB indication, a second rate-matching pattern for the first DL signal for the UE.

8. The apparatus of claim 7, wherein, to determine the second rate-matching pattern for the first DL signal for the UE, the at least one processor, individually or in any combination, is configured to:
determine the second rate-matching pattern for the first DL signal, wherein the first DL signal is not allowed to be scheduled overlapping with the set of transmission resources originally occupied by the one or more SSBs.

9. The apparatus of claim 5, wherein the at least one processor, individually or in any combination, is further configured to:
transmit a first acknowledge (ACK) corresponding to the first SSB indication, wherein the first rate-matching pattern is applied an interval time after the transmission of the first ACK.

10. The apparatus of claim 9, wherein the at least one processor, individually or in any combination, is further configured to, after the interval time after the transmission of the first ACK:
set a resumption timer, wherein a value of the resumption timer increases with each slot after the interval time; and
resume, in response the value of the resumption timer reaching a timing threshold, a transmission of the one or more SSBs.

11. The apparatus of claim 5, wherein, to receive the first SSB indication, the at least one processor, individually or in any combination, is configured to:
receive the first SSB indication via the first MAC-CE, and wherein the first MAC-CE includes at least one of:
a service cell identifier (ID) identifying a service cell, or
a bandwidth part (BWP) identifier identifying a bandwidth, and wherein the first SSB indication is applied to at least one of the service cell or the bandwidth.

12. The apparatus of claim 5, wherein, to receive the first SSB indication, the at least one processor, individually or in any combination, is configured to:
receive the first SSB indication via the first DCI, and wherein the at least one processor, individually or in any combination, is further configured to:
identify a set of candidate SSBs based on at least one of an RRC configuration and a MAC-CE configuration, and wherein the first DCI identifies the one or more SSBs from the set of candidate SSBs.

13. The apparatus of claim 12, wherein, to refrain from transmitting the one or more SSBs, the at least one processor, individually or in any combination, is configured to:
refrain, in response to the one or more SSBs being associated with the PDSCH scheduled by the first DCI, from transmitting the one or more SSBs.

14. The apparatus of claim 12, wherein the at least one processor, individually or in any combination, is further configured to:
transmit a first acknowledge (ACK) corresponding to the first SSB indication; and
determine the first rate-matching pattern for at least one second DL signal different from the first DL signal an interval time after the transmission of the first ACK.

15. The apparatus of claim 14, wherein the at least one processor, individually or in any combination, is further configured to:
receive, from the network entity, second DCI invalidating the first DCI;
transmit a second ACK corresponding to the second DCI; and
invalidate the first rate-matching pattern for the at least one second DL signal the interval time after the transmission of the second ACK.

16. The apparatus of claim 1, wherein, to refrain from transmitting the one or more SSBs, the at least one processor, individually or in any combination, is further configured to:
refrain, in response to the one or more SSBs not defining a cell, transmitting the one or more SSBs.

17. The apparatus of claim 1, wherein the UE is a first UE, and wherein the at least one processor, individually or in any combination, is further configured to:
refrain from scheduling a second UE for monitoring the one or more SSBs.

18. The apparatus of claim 1, wherein the at least one processor, individually or in any combination, is further configured to:
determine whether the one or more SSBs are associated with a prediction target resource for a channel characteristics prediction procedure, and, to refrain from transmitting the one or more SSBs, the at least one processor, individually or in any combination, is configured to:
refrain, in response to the one or more SSBs being associated with the prediction target resource for the channel characteristics prediction procedure, from transmitting the one or more SSBs.

19. The apparatus of claim 18, wherein, to determine whether the one or more SSBs are associated with the prediction target resource for the channel characteristics prediction procedure, the at least one processor, individually or in any combination, is further configured to:
receive, from the network entity, a channel state information (CSI) report; and
determine, based on the CSI report, whether the one or more SSBs are associated with the prediction target resource for the channel characteristics prediction procedure.

20. The apparatus of claim 18, wherein, to determine whether the one or more SSBs are associated with the prediction target resource for the channel characteristics prediction procedure, the at least one processor, individually or in any combination, is further configured to:
autonomously determine that the one or more SSBs are associated with the prediction target resource for the channel characteristics prediction procedure; and
transmit, to the network entity, an indication of the autonomous determination.

21-30. (canceled)
